(19) United States
(12) Patent Application Publication
(10) Pub. No.: US 2009/0129912 A1
(43) Pub. Date: May 21, 2009

(54) Device to dynamically lift and suspend loads

(76) Inventor: Samuel Gueller, Melbourne, FL (US)

Correspondence Address: Samuel Gueller, 6717 KELSEYS OAK COURT, CINCINNATI, OH, 45248, US

(21) Appl. No.: 12/151,987

(22) Filed: May 12, 2008

Related U.S. Application Data
(60) Provisional application No. 60/958,859, filed on Jul. 10, 2007.

(51) Int. Cl. B66C 3/00

(52) U.S. Cl. 414/785

(57) ABSTRACT

A mechanical device, powered by internal combustion engine or other source of power, inside an enclosure which is fixed on a platform with the purpose to lift and keep dynamically suspended loads by means of centrifugal force, such that once that force is equal or higher than the required to hold the load, there will be not measurable weight in the platform, except the device itself. The generator of centrifugal force is one or more arms with end-loaded weights rotating at variable speed to produce the lift and suspension required. First application is to increase the ordinance carrying capacity of military aircrafts, cargo planes and helicopters. Other applications are in the fields of civil aeronautics and space exploration.

### FIELD OF THE INVENTION

The present invention relates generally to the field of aeronautics and astronautics. Military use appears to be a priority, followed in due time to applications in civil aircrafts and space exploration.

### BACKGROUND OF THE INVENTION

It is common for an aircraft to have enough thrust to carry larger loads to increase these, while decreasing the former has eluded an immediate technical solution. A compromise was made to keep the thrust but adding extra power to divert the larger load's weight such that the aerodynamic drag on the aircraft is preserved, and a larger carrying capacity is obtained without compromising the propulsion.

Thus, there is an actual need to accomplish this goal.

### SUMMARY OF THE INVENTION

A mechanical device fixed on a platform to lift and keep dynamically suspended loads by mean of centrifugal force. First application is to increase the ordinance carrying capacity of military aircrafts, improve take off from carriers; for cargo planes and helicopters. Other applications are in the fields of civil aeronautics and space exploration.

### BRIEF DESCRIPTION OF THE DRAWINGS

FIG. 1 is a diagram in cross section view of the enclosed device

FIG. 2 shows springs when the device is at rest

FIG. 3 shows springs when the device works

FIG. 4 indicate how motive force is transmitted to the rotating arms

FIG. 5 suggested locations of the device in a plane or helicopter

FIG. 6 is a quasi-scaled device in operation

FIG. 7 shows heavy ordinance carried by lower capacity aircrafts

FIG. 8 are the basic applicable equations for computation

FIG. 9 graphs computations for preliminary design

FIG. 10 shows application of the device in a space shuttle

### DETAILED DESCRIPTION OF THE DRAWINGS

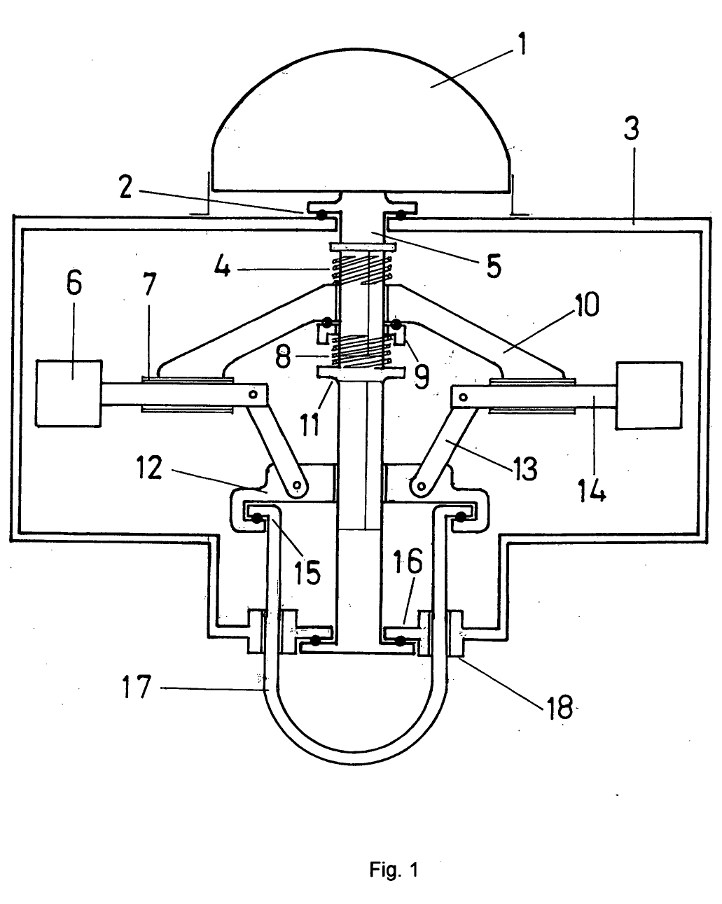

FIG. 1 In this diagram numbers identifies the following parts:
1 Cover of the power source, like engine of internal combustion
2 Upper bearing
3 Enclosure
4 Cushion string
5 Motorized shaft
6 Acting weights
7 Guide of displacing arms
8 Help spring
9 Easing bearing ring
10 Structural diagonals
11 Shaft's seat
12 Arms' joint
13 Connectors
14 Arms
15 Hanger's bearing
16 Lower bearing
17 Hanger
18 Hanger's guide

Cover 1 enclose any alternative source of power to operate the device. The motor inside can be connected by a direct line or solid means to the easing bearing ring 9, which is an elevation reference, to automatically change the rpm provided by the motor unit, reacting as needed for a pre-established bearing location.

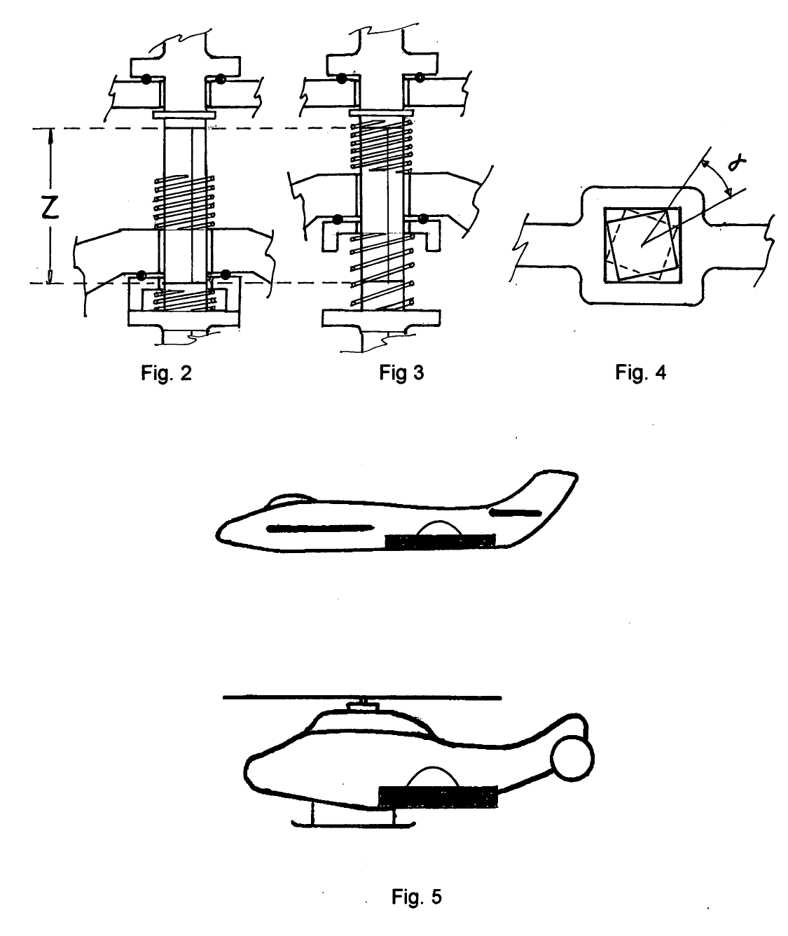

FIG. 2 When the device doesn't work whole loads and device itself rest on the shaft's seat 11, which in turn transmit everything to the carrying aircraft. The cushion spring 4 is idle because it is there to protect the rotating system to rise too high to avoid undesirable friction in extreme operational conditions.

FIG. 3 When the device works, the rotating ensemble will have no load's pressure against the shaft's seat 11 when the rpm are above the minimum required for such condition, but if it is in that minimum, the help spring 8 will distend and help the separation of the structural diagonals 10 from the shaft's seat 11 to eliminate contact. The easy bearing ring 9 also allows free partial rotation by the angle α as seen in FIG. 4.

FIG. 4 The motive power is transmitted to the rotating ensemble through two squared holes in the structural diagonals 10 and arm's joint 12, both have free vertical movement along the distance Z seen in FIG. 2 and FIG. 3 above the shaft's seat, and in both sectors of the shaft 5 in FIG. 1. Because the efficiency of the device depends on the isolation of the rotating ensemble, to minimize the friction that exist in vertical translation along the shaft, the motive force is transferred by line-contact between the shaft 5 and the structural diagonals 10 and arms joint's squared holes 12. Higher efficiency can be obtained by using vertical rolling bearings for such purpose.

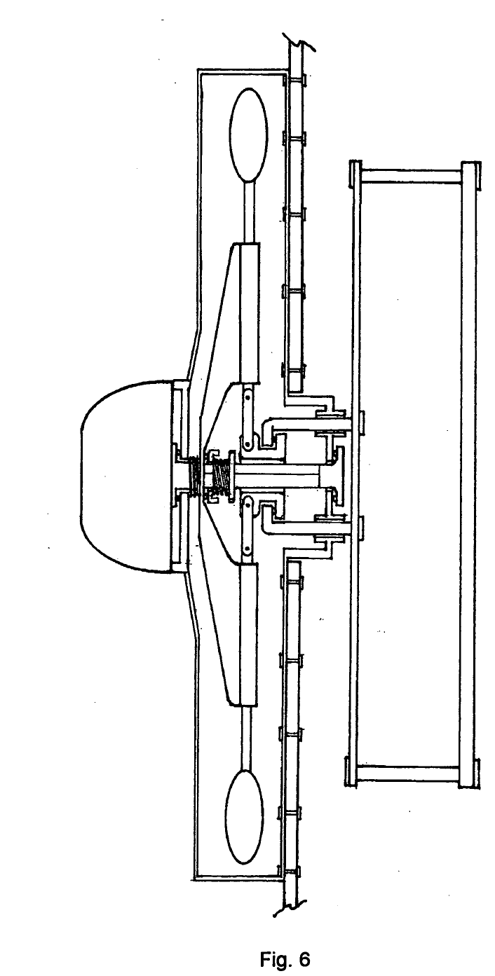

FIG. 5 Shows location of enclosure, loads could be external (helicopter) or internal (aircraft bay). Center of gravity for worst loaded conditions must be evaluated and fly specifications on in-fly operations and maneuvering.

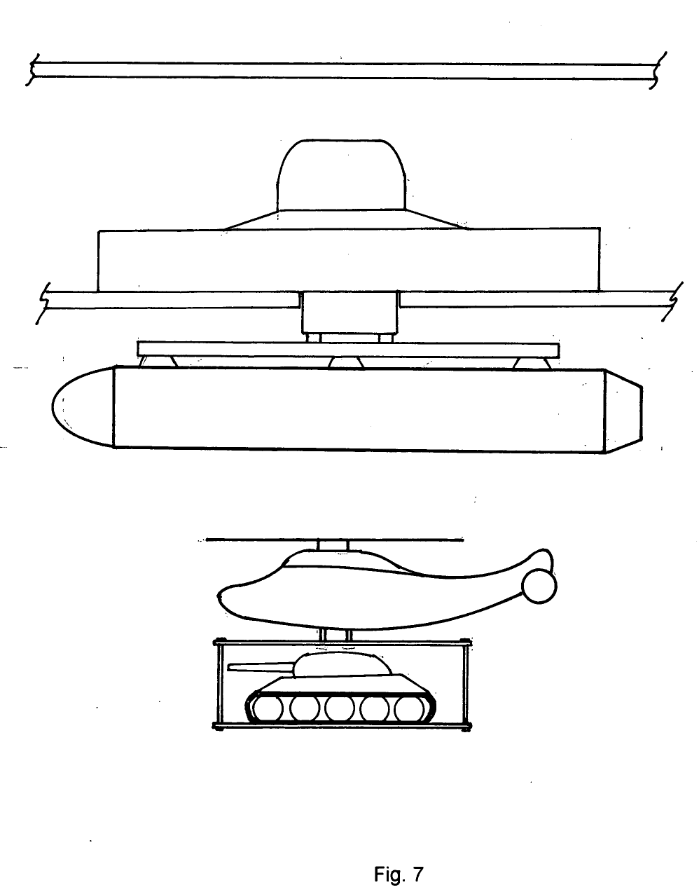

FIG. 6 This is a cross section of the active device showing the arms in its full extent to suspend a load from its middle point of rotation at shaft center, and platform where the device is attached to the floor of a carrying aircraft. Proper scaling requires use of the final dimensions which are dependent of each specific design.

FIG. 7 Shows Multiple One-Ton bombs increased carrying capacity, and helicopter to transport heavier equipment.

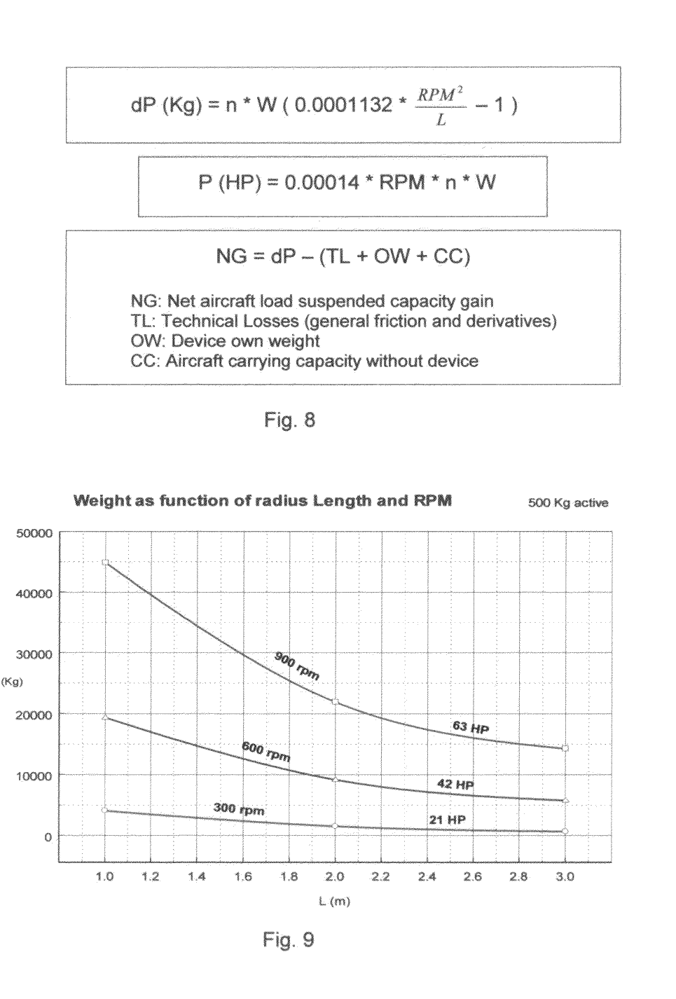

FIG. 8 Here are included formulas derived from classical mechanics, for overall extra lift/suspension dP, and required power in HP obtained from the standard equation of mechanical driven rotating mass, taken torque in Kg.m. And an expression to quantify net lift/suspension gain by using the device.

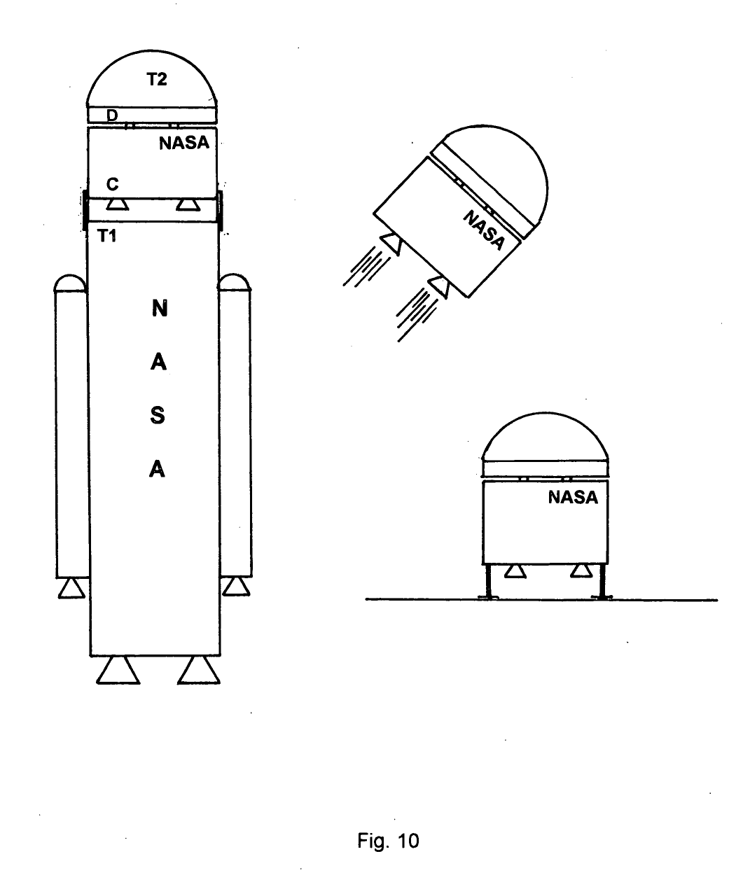

FIG. 9 This is an example of graph to help the detailed design process, which could follow the steps: (1) Knowing the geometric limitations where to be installed, find the arm length L (meter), (2) Know the maximum rpm possible to use, (3) Determine the load at extreme of arm(s), and how many arms to use, (4) Find out lift/suspension capacity in kilograms, discount losses and own weight, and (5) Prepare construction specifications.

FIG. 10 This is an assumed application for a space shuttle, despite many solutions has been proposed, this one offer the unique characteristic of weightlessness at take off, travel and landing.

### DETAILED DESCRIPTION OF THE INVENTION

This device is activated by a rotating power means 1 like an internal combustion engine, electrical motor, atomic energy power unit, or other; which power a shaft 5 resting on two flat bearings 2 and 16 to keep it vertically stable. An enclosure 3 contain a free flying mechanism rotating at variable speed, composed of the following pieces: Arms 14 freely resting on bearing 9 and subsequently on seat 11, and an arm's joint 12 tied to the arms by connectors 13.

The arms 14 moves perpendicular to the shaft 5, at the end of these arms are fixed equal weights 6. Guide for displacing arms is self explanatory. Nonetheless, proper computations for vertical acting forces need to be carefully done.

One bar 13 per arm connect the arm's joint 12 to the central ends of the arms, the arm's joint has an squared opening a little larger than the squared cross section of shaft 5 to permit free longitudinal displacement but have contact to provide the required push for rotation. The joint 12 provides support for a hook type of element 17 to keep it in no-rotating condition by means of a bearing system 15 and guide 18 for vertical displacement. This guide 18 is needed even if a counter-rotating system is added as an additional rotating arm, for safety.

When a load hangs from hanger 17, or an attachment is devised to sustain loads, or a pallet is used instead of a hanger, and the power unit starts, the whole free floating device inside the enclosure rotates at increasing circular motion, the centrifugal force will move the arms 14 in opposite directions risen the joint 12 up to the coaxial position with the arms, generating the force that lift the load, that is the maximum elevation attained with the system as FIG. 6 shows. When the weight reduction is complete the pressure of seat 11 will be zero. The device's rounded enclosure is for protection, it can contain a counter-rotating similar system with an appropriately designed joint for stability and vibration control.

The graph in FIG. 9 illustrate how with two acting weights of 250 Kg each are obtained lift capacities of 20,000 Kg-45,000 Kg within 600-900 revolutions per minute, with arms of 1 m length or 2 m enclosed diameter, and the required power range is 42-63 HP. If the power goes off, the full weight of the load will act on the enclosure or platform where it is located, by the bearing seat 11 which is the only connection of the free rotating arms' system to the said enclosure and platform. Additional centrifugal force must be available if the platform (aircraft) moves upward to counteract some friction at 11 due to that change of shaft's spatial position. The same correction applies in opposite direction if the aircraft moves downward. The net suspended capacity dP for weight reduction is calculated from physics as

$$dP ( Kg ) = n * W ( 0.0001132 \frac{R P {M}^{2}}{L} - 1 )$$

where W (Kg)=weight at end of one arm; n=number of arms; L (meter)=length of arm; and RPM=revolutions per minute.

The power is: P(HP)=0.00014*RPM*n*W

The net gain of the aircraft carrying capacity is given by:

NG=dP−(TL+OW+CC)

where,
NG: Net aircraft load suspended capacity gain
TL: Technical losses (general friction and others)
OW: Device own weight
CC: Aircraft carrying capacity without device

The weight reduction is obtained by the rotating arm's weights that generate a spatially stable plane parallel to the earth surface due to its inertial forces which are function of the angular momentum and its correlatives (it is constant if no external forces/weight are acting) these inertial forces decrease by air friction or diminish by the contrary force of the loads.

Therefore, an addition of power is constantly required for counteraction, in such a way that the original inertia is restored and will remain constant so far no other force alter its stability. By lack of power the said plane, and load will move toward earth and pressure will occur on seat 11.

Weightless is complete when the spring 8 is full distended, if it is not full, the weight needed to account for a partial compression is considered a loss. Losses of the device-only are located at mechanical components 9, 10, 12, and 15, which are generated by friction by translation at 10 and along the main shaft at 12; or rotation at 15 and partial rotation or no rotation at 9.

Once lift is complete as seen in FIG. 6 the hanger's guides 18 will keep the hanger 17 fix for a smooth work of bearing 15 subject to the specified dynamic load rating. Bearing 15 reference type is Timken's Tapered Roller Thrust Bearing Products Catalog B457.

There is a dual phenomenon occurring alternatively, free fall and lifting of the load. After free fall ends, lift develops and there is no weight, but in the transition of an infinitesimal of time, weight exists. To cancel this transition is necessary to add a little more centrifugal force than the minimum required to prevent that a measurable weight is added to the system by the load. The additional force could be in the order of 5% of the obtainable dP, which need to be taken in consideration when efficiency of the system is computed.

For space technology only suggestions can be made because many collateral problems need to be solved to take advantage of weightlessness. In FIG. 10 T1: Lift off fuel tank, T2: Service tank for trip fuel, D: variable weight device, C: Cabin and cargo volume. At lift off maximum, T1 is smaller, but total fuel is T1+T2. Advantages are: Travel space at higher speed with less travel time, upgrade with artificial gravity in the cabin can be obtained by the own nature of the device by transferring some of the rotation to the cabin itself, very low descent speed and consequent controllable earth atmospheric re-entry velocity. Cabin and attached device and service tank can be re-used.

Thus there has been described a device to dynamically suspend loads by means of centrifugal force that reduces the effect of weight on the carrying aircraft reducing fuel consumption, although fuel is used to operate the device. While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

### Acquired Workshop Experience While on “Patent Pending” Status

### 1. Component Parts

The components parts are: Structural Frame, Shaft, Load rotating arms of variable length, Power source on frame with forces and moments directed by a truss to the platform, not to the main shaft. In fact it is a job of low to medium mechanical expertise, which can be easily executed if well designed which is critical due to the fact that proper combination of the variable's values involved make the device works satisfactorily. The Standard Configurations Table attached is a guide to design in the ranges desired.

### 2. Computer Tools

The most important are equation's detailed development, and computational software. The best advice is to keep them confidential because are the tools to optimize designs to have the competitive edge in the industry.

### 3. Use of rpm²/L to Optimize Arm's Length

We observe from the equation for dP and simple verified as physical phenomena, that the shorter the length of the arm the better and it is a plus. But imply a larger rpm, and this is a minus. Care need to be taken when we want to compare different lengths, because all other variables must remain constant, a decreasing length must use an increase rpm. The best way is to take the first length as 100% but as 1; and the second tested as a percentage of the first meaning a percentage of 1, namely a decimal fraction which will increase rpm. e.g., 0.5 is % that will duplicate rpm.

### 4. Concept to Suspend Loads (in Space) to Cancel Pressure (Weight) on Frame

It appears that there is not actual solution to antigravity of a static body, but all partial solutions rest in a dynamic process, which this is one of them with its own characteristics. The work done by the device, efficiency and performances permit a multitude of applications, which made attractive its implementation in the sense that provide solution to practical requirements.

The idea to transfer the weight of the device only to a platform instead of trying to levitate the load can make it useful if the lifted and suspended load is much greater than the device itself and uses a reasonable power requirement for the dynamic process. Conservative care in the design must be a must, and precise construction.

The automatic operation is obtained in a type of feedback loop similar to the vapor engine's Watt regulator, consisting in a connection between two points: the level of the arms above the floor of the frame and a lever of an accelerator of an internal combustion engine, or actuator of a variable speed motor.

### 5. Deflection to Measure Weight Loss of Loads

The basic concept to keep a load suspended in space is to be restrained by horizontal forces instead of vertical reacting against gravity forces. The problem is that it is no possible to obtain a 100% of suspension due to static deflection. Nonetheless, if the distances between the end points decrease approaching zero the deflection also approaches zero. Then, in any configuration the shorter the length the better and, if the force is generated by a dynamic process (rpm) that can be increased up to a satisfactory level, then it is practicable.

### 6. Preparing for Assembling and Testing

A standard linear rotation bearing is used for vertical movement of metal elements in this device to minimize friction while having a good vertical adjustment. A thrust bearing type and mounting is critical because the load will hang from a moving supporting element and the loss by friction need to be optimized.

Photos 1 thru 3 tests a scaled lab model with a motorized main shaft using a loads with two small weights at diameter's end points, and a run was made where the driving power equal the required for suspension. For each rotating gram at the end of each arm there are 9 grams floating in the air. Under this condition the weightlessness appears if we weight the system as a whole.

The frame does not rotate enough to suspect a problem in a chopper system. In general the frame must be fixed on a platform such that any frame movement will not is transmitted to the carrier. A final option if needed is a double counter-rotating arm to minimize rotation and vibration.

### 7. Testing Operation and Performance

This is a self explanatory test as shown, and the intent is to get a direct reading of the loss of weight on the platform.

### 8. Military and Civil Applications

The main advantages in the use of this device are:

Easy to design and build

Boxed-compact for installation

Easy to control

Quick change of lift capacity rate

Low cost

### Military

(Due to many military possible applications, it is not advised at this time to disclose any. Not to the public either, for risks associated with its misuse or security concerns for the population. Therefore, all designs or construction for specific uses, military or civil, are not considered until full test and evaluations determine safe procedures to follow.)
Main areas for use are:

Additional fuel carrying capacity

Plane vertical takeoff facilitator

Plane horizontal shorter takeoff

Cargo plane improvement

Helicopter:
Military hardware transport with low capacity chopper
Transport of more troops
Civil and Military medical activities
Civil emergency assistance and deliveries

### Civil

(1) Crane lifting capacity increase, indoor and outdoor. (2) Combined with helicopter's type rotor, obtain an acceptable urban flying car. (3) Firefighter helicopter or plane for high water volume carrying capacity. (4) Cargo plane increased carrying capacity, (5) Improvement in transport trucks efficiency, (6) Others.

### Potential in Space Exploration

Smaller liftoff propulsion systems

High speed in space travel

Softer descend and coupling anywhere

Lower speed atmospheric re-entry

What is claimed is:

1) A mechanical assembly comprising:
a powered rotating shaft;
a rotating system of displaceable weight loaded arms;
an attachment to hold weights; and
an enclosure.

2) The mechanical assembly of claim 1, further including one or more arms.

3) The mechanical assembly of claim 2, wherein the type of arm's joint is connected to one or more arms.

4) The mechanical assembly of claim 3, further not including the arm's joint, but both radial arms are solid connected, continuous, as a single diameter arm for all diameter arms used, up to the solid disk configuration.

5) The mechanical assembly of claims 3 or 4, wherein the power source is any which can provide rotation, torque, rpm, and any other need required in an operating system.

6) The mechanical assembly of claim 5, wherein have a hanger to hold loads, pallets, or similar specific attachments as needed to secure loads.

7) The mechanical assembly of claim 6, further including other type of arms and guides for displacing arms.

8) The mechanical assembly of claim 7, further including controls for loading, transport, and downloading any type of weight.

9) The mechanical assembly of claim 8, further including actuators and controls to keep loads internally and/or externally complying with requirements of stability while the platform (aircraft or similar) moves, fly, or maneuvers on ground or on water, in the air, or in space.

10) The mechanical assembly of claim 9, wherein it is applied to use in helicopters, plane of horizontal or vertical take off, cargo planes, space shuttle or other apparatus for space exploration including the propulsion system, and other non-aeronautic or astronautic application.

11) The mechanical assembly of claim 10, further including alternative solutions (like a similar device in counter-rotation) for stability of the system and prevent vibration.

12) The mechanical assembly of claim 11, wherein a structurally appropriate enclosure is designed to contain the system.

13) The mechanical assembly of claim 12, further including the location of arm's weight along its length instead of at its extreme.

14) The mechanical assembly of claim 13, wherein are used metallic, alloys, composites or other materials as needed for a specific purpose.

15) The mechanical assembly of claim 14, further including any type of fix of the system to the aircraft infrastructure.

16) The mechanical assembly of claim 15, further including rotation controls for power source, automatic and manual.

17) The mechanical assembly of claim 16, further including sensors for relative location of rotating device inside the enclosure, referred to maximum displacement along the power shaft.

18) The mechanical assembly of claim 17, wherein are added means to tilt the plane of arm's rotation to keep it parallel to the ground surface, automatic or manually.

19) Adaptation of this device to standard rotors helicopters to obtain same increased lifting and carrying capacity.

20) Application or adaptation of this device to other than to the aeronautics or astronautics fields.
